(19) United States
(12) Patent Application Publication
(10) Pub. No.: US 2025/0385902 A1
(43) Pub. Date: Dec. 18, 2025

(54) Automatic Extraction of Log-In Security Questions and Answers from Personal Devices

(71) Applicant: Duquesne University of the Holy Spirit, Pittsburgh, PA (US)

(72) Inventor: Patrick Juola, Pittsburgh, PA (US)

(73) Assignee: Duquesne University of the Holy Spirit, Pittsburgh, PA (US)

(21) Appl. No.: 19/190,955

(22) Filed: Apr. 28, 2025

Related U.S. Application Data
(60) Provisional application No. 63/639,855, filed on Apr. 29, 2024.

(51) Int. Cl. H04L 9/40

(52) U.S. Cl. CPC H04L 63/083

(57) ABSTRACT

The present invention is an automated data-extractor which is pre-set to extract specified data from a user's personal device (such as but not limited to a smart phone), and then to present that extracted data to the user for verification by recognition, not by recall, as part of a security log-in protocol. Recognition is much easier, for a user, than outright recall, and therefore the present technology provides a user-friendly way to verify an individual during a log-in procedure. The invention thus embraces at least a two modules containing (a) a data extractor module and (b) a combination generator module which presents the extracted data to the user in a question-and-answer mode to prompt “yes” or “no” verification of the data extracted, but requiring only recognition as to the user's own data, not completely unprompted recall.

Field of the Invention The present invention is an alternative to recall-reliant security verification during sign-in to web sites, applications and other secure computer interfaces.

### BACKGROUND OF THE INVENTION

After simple password security—for web sites, applications and other computer use scenarios—proved to be inadequate over time, two-stage (or more) verification became popular, to try to ward off log-ins by unauthorized users. Two-stage (or more) computer verification often include security questions. Unlike in times past, however, the identification of a “mother's maiden name” or “birthplace city” are today easily researched and ascertained. Clearly, with “security” questions that have easy-to- duplicate answers, there is virtually no genuine security at all. Moreover, a “favorite” (food, flower, song, etc.) is a subjective matter, that can change over time. Worst of all, these systems often demand “recall,” that is, application of human memory with little or no prompting—which can be a challenge for a user. A need therefore remains for an automated means to verify a user to a computer, typically during a log-in procedure, which in particular reduces or eliminates the need for active user “recall,” while also avoiding security questions that a third party can easily circumvent and subjective answers that can and do change over time.

### SUMMARY OF THE INVENTION

In order to meet this need, the present invention is an automated data-extractor which is pre-set to extract specified data from a user's personal device (such as but not limited to a smart phone), and then to present that extracted data to the user for verification by recognition, not by recall, for secure log-in protocols. Recognition is much easier, for a user, than outright recall, and therefore the present technology provides a user-friendly way to verify an individual during a log-in procedure. The invention thus embraces at least a two part module containing (a) a data extractor module and (b) a combination generator module which presents the extracted data to the user in a question-and-answer mode to prompt “yes” or “no” verification of the data extracted, but requiring only recognition as to the user's own data, only, not completely unprompted recall. (The invention typically also includes a third module, to provide randomly generated data not originating from the user, to provide “distractor sets” for verification queries.) The inventive data extractor/processor is therefore a technology which allows personal security verification by the user's identification of data from his or her personal device. Data to be extracted includes, without limitation, contacts, images, media, calendars, applications, or other data associated with any of these. By initially scanning a device (including, without limit, a cell phone, tablet, laptop computer, or other personal device), the data extraction module extracts and identifies a collection of associated data elements personal to the user. The prospective user is then asked to recognize and validate their own personal data, unique to them, by correctly recognizing their own data-as distinguished from random data-typically in three cycles of consecutive positive data verification. These consecutive successful data verifications then confirm the log-in identity, of the user, to the computer-based entity (web site, application, etc.) for which secure log-in is desired.

### BRIEF DESCRIPTION OF THE DRAWINGS

FIG. 1 is a flow chart which illustrates the steps of the claimed method.

### DETAILED DESCRIPTION OF THE INVENTION

The present invention is different from “tracking habits” technologies used by search engines, to monitor and store information about users, such as are ubiquitous on Google and other similar providers. As is well known, search engines routinely track the searches, site visits, browsing histories and so forth of individual users, and deploys such data in all sorts of ways. By contrast, the present invention is a specifically consented-to data collection application to extract specific data from a personal device of a user, so as in context to allow a user to identify themselves to a third-party computer by verifying the data on their own personal device (a “phone”), all in an automated fashion. As a simple, single example-the data extraction and associated module could query, “Which of these ten photographs is among the three most recent photographs captured by the camera on your smart phone?” and the genuine user would be able to answer this question correctly, using recognition, discerning which of the nine remaining photographs were foreign to the user's personal device. However, to overcome the statistical possibility of subverting such a query by chance correct answers by an imposter (which imposter could be another user, an Artificially Intelligent entity, etc.) the data extraction and verification typically proceeds through at least three successful verification cycles, to prevent subversion by a bad actor.

For illustrative purposes, and without intention to be limited thereby, a typical set of data for extraction can be the three categories of “photos, email contacts, and media consumption.” The technology extracts and requires verification of data from all three (or more) categories to avoid a statistical chance of an imposter's “beating” the challenges by chance. Each category is described further, as a non-limiteing example, as follows. (1) Photos: as with a CAPTCHA, the prospective user can be presented with an array of photos from their phone, mixed with other, random, images selected from public sources, stock photos, other users (if privacy settings permit), and so forth. The prospective user is asked to identify which of the photos presented are familiar to them, and the present technology that extracted the user's own photos in the first place also verifies (if applicable) that the selected photos are indeed those of the user. (2) Email contacts: the user is presented with a list of email contacts (e.g. “Example Person person.example@xyz.com”) some from the user's phone, and some gathered from external sources, and again asked to identify which of these individuals are personal correspondents of theirs, with the technology verifying correct or incorrect choices. (3) Media consumption: users can be presented with titles of songs, movies, and books that have been stored on their phone as well as titles gathered from external sources, and asked to identify which of these songs/movies/books they have listened to/watched/read. Finesse involved in implementing the data extraction with this technology includes the consideration that not all data in one's personal device is equivalent. For example, a movie that is extremely popular will have been seen by nearly everyone and a hostile attacker would be able correctly to guess that such a movie has been viewed by the user. On the other hand, a user may not remember a song from an auto-generated playlist from five years ago, or a photograph might be too easily identified if the user appears in the photograph. Nonetheless, these finesses are manageable and within the ordinary skill of the art to accommodate, in designing the data fields to be extracted (with selected data to be excluded) and limitations for same. After the user has successfully identified a large enough set of familiar and unfamiliar data items with sufficient accuracy—usually at least three correct verification cycles in succession—the user will have validated their identity. Upon identity validation, computer access can be granted automatically, as the final security step of any login procedure embracing the present technology.

The present invention solves several important problems which prior technologies cannot. First, with this technology a user can identify oneself even without access to the actual personal device from which data has been previously extracted, such as on a day the device has been misplaced, forgotten, battery-discharged, lost, stolen, broken, or is simply unavailable. The importance of being able to continue to function, to log-in as needed and to continue to function in the world today—without immediate access to one's smart phone—cannot be understated. This technology also solves the problem of avoiding security questions whose answers can be easily researched (mother's maiden name, etc.). Even if a usurper had an idea of a user's favorite book, for example, he or she would not know ALL the books the user had read recently. Finally, the data extraction can be periodically and readily updated to reflect new developments-new photos, new contacts, new media, and (for example) new video series' viewed or streaming services recently added. With periodic updates, the technology will provide up-to-date user verification data and not rely on security questions that may not only be insecure (as to their answers) but also historically out of date.

Unlike “search tracking” technologies used by internet engines, the present modules are defined, limited and highly personalized. The data extraction module pre-selects certain data types and collects only those data types from the user's personal device as an initial security upload, all with the prior consent of the user. Typically, the data types extracted are in at least three categories, more preferably at least four categories, and in some cases five categories. The second combination generator module contains question-and-answer interfaces that present extracted data to the user, together with random, other data (in the same categories) for the user to distinguish. Interestingly, the present invention differs from a CAPTCHA in that photos, images, graphics and other data presented in a CAPTCHA challenge are all randomly generated from an outside source—in the present invention the challenge data and images include those extracted from a user's own personal device, for the user to verify. In other words, whereas CAPTCHA challenges rely virtually completely on randomly generated images and data, the innovation of the present technology inheres in pertinent part in the data extraction of personal data from the device of a user, combined with other, tracked random data (as distractor sets). In this way, the device of a user is wielded as having a “fingerprint” of its user, as indeed all user's devices do indeed have—such that such a fingerprint becomes a practical means of identifying a user during any computer log-in protocol.

Given that the present invention is similar to CAPTCHA except that the data extraction is of prescribed data in a user's own personal device, similar architecture to CAPTCHA may be used in the detailed deployment of the present invention. Again, a key difference between the present invention and CAPTCHA is that, in CAPTCHA, the data and images are all random-whereas in the present technology at least some of the data and images are extracted from the user's own device. The ensuing paragraphs provide some guidance in designing and deploying the present technology as to architecture, in a manner similar to (but with key differences already explained) CAPTCHA. By the way, CAPTCHA stands for “Completely Automated Public test to Tell Computers and Humans Apart.” Interestingly, the present invention is fundamentally different from CAPTCHA, and instead is designed to be a completely automated private test to tell one user, authoritatively, from any other user.

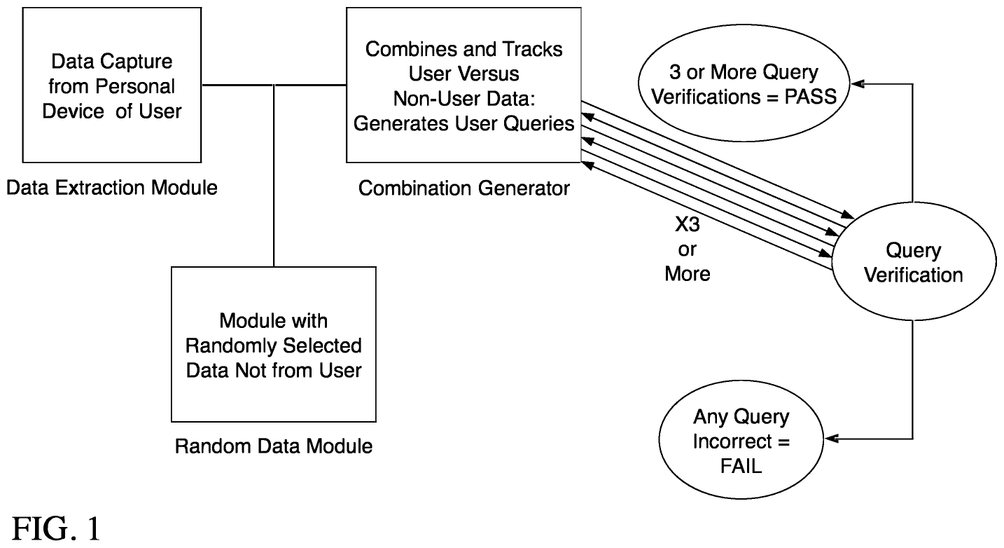

Referring now to FIG. 1, a data extraction module captures data from a designated personal device of a user, such as a cell phone, tablet, laptop, or any computer-based personal device. The data extraction module cooperates with an adjacent random data module, which is populated with randomly selected data (pictures, e-mail addresses, telephone numbers, etc.) not specific to the user. The data extraction module and the random data module then cooperate with a combination generator, which combines and tracks user versus non-user data to generate user queries for verification by recognition, not outright unprompted recall. The combination generator typically generates at least three cycles of queries for verification by the user, signified by the three sets of arrows between the combination generator and the query verification unit. If three or more consecutive verifications occur, after user recognition of the user's own data as contrasted with randomly-generated non-user data, the present technology verifies the identity of the user and completes the log-in procedure into which the present invention has been combined.

Although the invention has been described in detail above, with particular emphasis on various specifics, modules and interactions, the invention is only to be limited insofar as is set forth in the accompanying claims. For example, individual users who back-up their smart phone or other device data to an external source, such as can be referred to as for instance “in the cloud,” can participate in the present technology due to cloud-extraction, not device extraction, to achieve the same result. Sophisticated users know to put comparable security access controls on their cloud data as they do on their device data and, indeed, the equivalence of personal device data and personal cloud data will predictably continue to grow, in both the short and long terms.

I claim:

1. A computer-driven application to verify a user during a log-in procedure, comprising:
a) a data extraction module which extracts and stores pre-determined data from a personal electronic device of a user;
b) a random data module, which stores random data sets originating from sources other than said user and analogous to the pre-determined data extracted from said personal device;
c) a combination generator which combines data from each of said data extraction module and said random data module, to present queries to a user, to which queries said user must identify said user's own data by recognition according to said user's answers to said queries, wherein said questions are presented in at least three cycles, addressing different categories of pre-determined data each time; and
d) an automated output to a computer, wherein when said user correctly answers three cycles of queries in succession, said user's identity is automatically verified for successful log-in to a computer.
